(19) United States
(12) Patent Application Publication
(10) Pub. No.: US 2013/0313095 A1
(43) Pub. Date: Nov. 28, 2013

(54) KEY STRUCTURE

(71) Applicants: LITE-ON ELECTRONICS (GUANGZHOU) LIMITED, Guangzhou (CN); LITE-ON TECHNOLOGY CORPORATION, Taipei City (TW)

(72) Inventor: CHIEN-HSIN LEE, New Taipei City (TW)

(73) Assignees: LITE-ON TECHNOLOGY CORPORATION, Taipei City (TW); LITE-ON ELECTRONICS (GUANGZHOU) LIMITED, Guangzhou (CN)

(21) Appl. No.: 13/684,560

(22) Filed: Nov. 25, 2012

(30) Foreign Application Priority Data
May 23, 2012 (CN) 201220232196.3

(51) Int. Cl. H01H 13/84

(52) U.S. Cl. CPC H01H 13/84
USPC 200/5 A

(57) ABSTRACT

A resilient key structure includes an insulating layer, a pressing unit, an upper cover, a first conducting layer, a second conducting layer, and a spacer. The pressing unit is mounted on the insulating layer and includes a plurality of pressing members. Each pressing member partially defines a sealed receiving space filled with a fluid. The upper cover is mounted on the pressing unit and defines a plurality of openings penetrated by the pressing members. The first conducting layer is mounted to the underside of the insulating layer. The underside of the first conducting layer has a plurality of first conducting portions. The second conducting layer is arranged underneath the first conducting layer and has a plurality of second conducting portions directly facing the first conducting portions. The spacer is disposed between the first and second conducting layers and defines a plurality of through holes.

### BACKGROUND OF THE INVENTION

1. Field of the Invention

The present invention relates to a key structure; more particularly, to a resilient key structure providing more comfort to a user and having simplified structural configuration, thus achieving miniaturization and increasing the yield rate.

2. Description of Related Art

Key structures are used widely among desktop computers, laptop computers, and mobile phones. However, key structures are typically made of hard materials. An elastic member, usually made of plastics, is employed to achieve self-return after the key has been pressed. Hence, the keys and the elastic members are normally installed on a keyboard in an individual manner. A predetermined separation distance is maintained between adjacent keys to allow sufficient pressing space.

However, in practice, several deficiencies exist. For example, noise is generated when stroking the keys made of hard materials. After repetitive stroking over long periods of time, the fingers may experience discomfort as well. Structurally, existing keys have certain height that makes product miniaturization more difficult and less environmentally friendly. In addition, the bottom layer of the key structures and the conducting portions often co-exist on the same article. During existing manufacturing process, the conducting portions are easily misarranged. Thus, electrical conductivity is adversely affected and the whole key structure may need to be obsoleted. These issues drive up the manufacturing cost.

### SUMMARY OF THE INVENTION

The present invention provides a resilient key structure, such that a user is less likely to experience discomfort after stroking the keys for extended period of time. The “touch” or “feel” of the key is also enhanced. In addition, the separation of the key structure and the signal device can significantly increase the production yield rate and reduce the manufacturing cost.

The key structure of the present invention comprises an electrically insulating layer, a pressing unit, an upper cover, a first conducting layer, a second conducting layer, and a spacer. From the top toward the bottom, the upper cover, the pressing unit, the insulating layer, the first conducting layer, the spacer, and the second conducting layer are arranged sequentially.

The pressing unit is disposed on one side (i.e., the upper surface) of the insulating layer. The pressing unit includes a plurality of pressing members. Each pressing member has a pressing face and four side faces. The pressing face and the side faces of each pressing member and the insulating layer cooperate to define a sealed receiving space. The receiving space is filled with a fluid (gas or liquid). The upper cover is disposed on the pressing unit. The upper cover is formed with a plurality of openings penetrated by the pressing members. The openings function to retain the side faces of respective pressing members. The first conducting layer is disposed underneath the insulating layer. The underside of the first conducting layer is formed with a plurality of first conducting portions. Each first conducting portion is paired with a discrete pressing member. The second conducting layer is arranged vertically under the first conducting layer. One side (i.e., the upper surface) of the second conducting layer is formed with a plurality of second conducting portions. Each of the second conducting portions is paired with respective first conduction portion. The spacer is disposed between the first and second conducting layers. The spacer is formed with a plurality of through holes. The through holes allow the first conducting portions to face unobstructedly toward the second conducting portions.

When any of the pressing members is depressed by a user, the applied force is transferred to the insulating layer through the fluid inside the receiving space. The insulating layer is forced downwards to squeeze the first conducting layer. The first conducting layer flexes downward, which moves the first conducting portions into abutment with the second conducting portions via the through holes. Thus, the first conducting portions are electrically connected to the second conducting portions.

For advantages, the key structure of the present invention provides comfort and is cost-effective. More specifically, when the user is stroking the keys repetitively for extended periods of time, the unwanted, painful pressing of the tendons is less likely to occur while operating in a more relaxed, reduced-stress manner. The stroking of the keys is also quieter. Meanwhile, during the manufacturing process, the pressing unit is first combined with the insulating layer. The insulating layer is then combined with the first conducting layer. Thus, when any of the pressing members of the pressing unit shows abnormality, the pressing unit can be immediately replaced to increase the yield rate. The signal device can be saved without having to replace it. Thus, cost-effectiveness can be achieved.

In order to further appreciate the characteristics and technical contents of the present invention, references are hereunder made to the detailed descriptions and appended drawings in connection with the present invention. However, the appended drawings are merely shown for exemplary purposes, rather than being used to restrict the scope of the present invention.

### BRIEF DESCRIPTION OF THE DRAWINGS

FIG. 1 is an assembled view of a key structure of the present invention.

FIG. 2 is an exploded view of the key structure.

FIG. 3 is a partial exploded view of the key structure.

FIG. 4 is a cross-sectional view of the key structure.

FIG. 5 is a cross-section view of the depressed key structure.

FIG. 6 is a schematic view showing the circuit layout of the conducting layers.

### DETAILED DESCRIPTION OF EMBODIMENTS

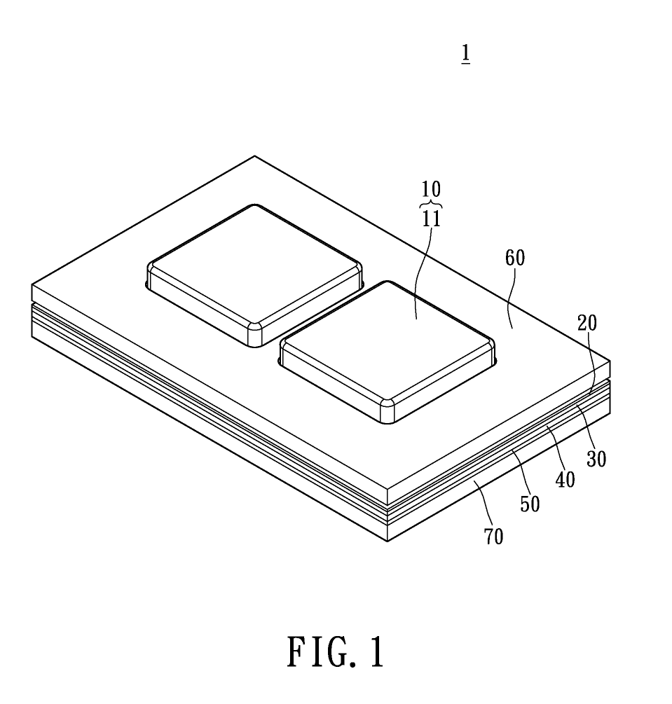

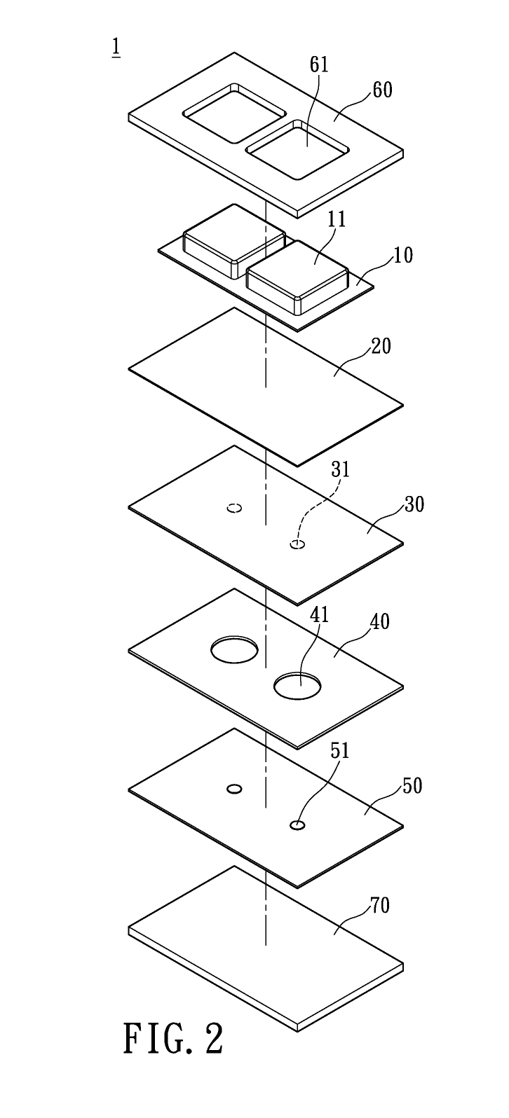

Please refer to FIGS. 1 and 2, which show an assembled view and an exploded view of a key structure 1 of the present invention, respectively. The key structure 1 comprises a pressing unit 10, an electrically insulating layer 20, a first conducting layer 30, a spacer 40, and a second conducting layer 50. From the top toward the bottom, the pressing unit 10, the insulating layer 20, the first conducting layer 30, the spacer 40, and the second conducting layer 50 are arranged sequentially. The key structure 1 can further comprise an upper cover 60 and a lower cover 70.

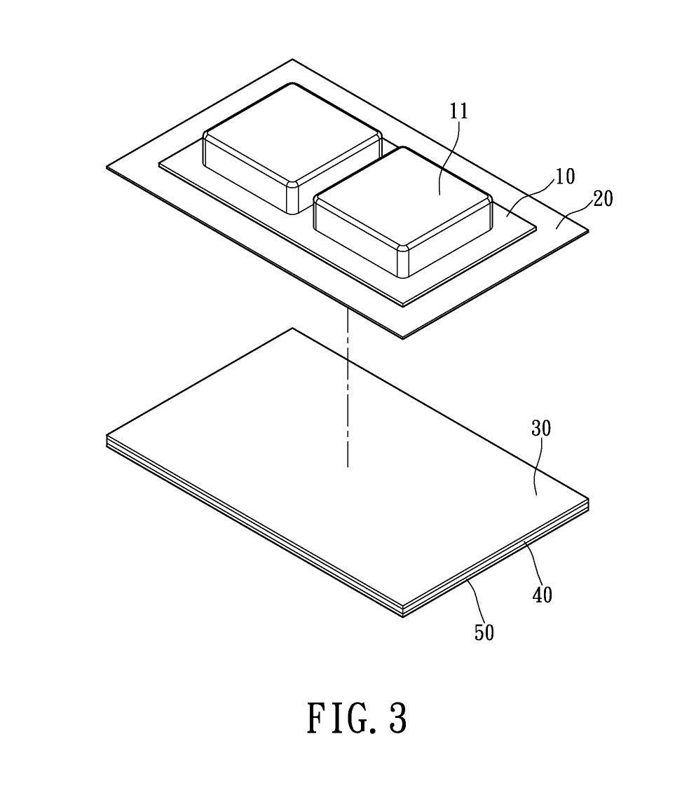

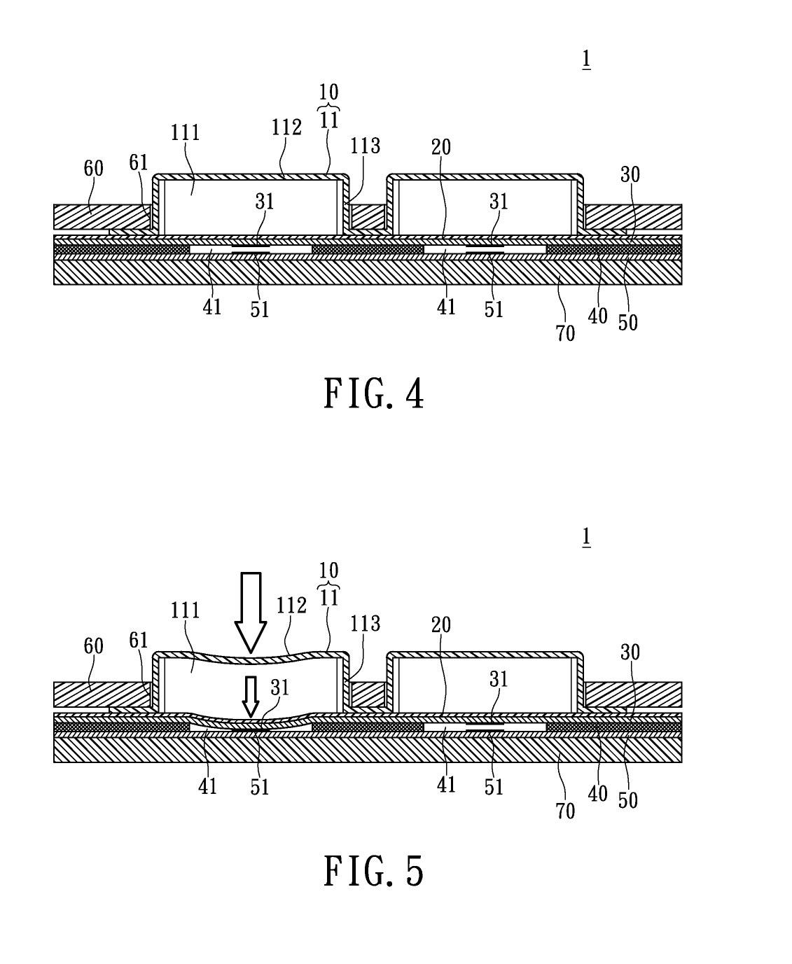

Please refer to FIGS. 3 and 4, which show a partial exploded view and a cross-sectional view of the key structure 1 of the present invention, respectively. The pressing unit 10 is disposed on one side (i.e., the upper side) of the insulating layer 20. The pressing unit 10 includes a plurality of pressing members 11 formed integrally thereon. The pressing members 11 can be made of materials such as plastic, silica gel, resin, and other macromolecules, but are not restricted thereto. Each pressing member 11 has a pressing face 112 and four side faces 113. The pressing face 112 forms the top face of each pressing member 11 for touching by the fingers of the user. The shape of the pressing face 112 may be characterized as convex, concave, or flat without restriction. A letter, digit, or symbol may be assigned to each pressing face 112 in allowing the user to distinguish from individual key structures 1. The side faces 113 are formed extendingly from respective edges of the pressing face 112. The side faces 113 are less resilient relative to the insulating layer 20 and the first conducting layer 30. In other words, the side faces 113 can be made of a material having a greater hardness than that of the insulating layer 20 and the first conducting layer 30. Alternatively, the side faces 113 can have greater thickness to increase rigidity. However, the means to make the side faces 113 less resilient relative to the insulating layer 20 and the first conducting layer 30 is not restricted.

Each pressing member 11 partially defines a receiving space 111 that encloses a fluid. The pressing face 112 and side faces 113 of each pressing member 11 and the insulating layer 20 cooperate to define the sealed receiving space 111. The receiving space 111 is filled with adequate amount of fluid (i.e., gas or liquid). For example, air, inert gas, or nitrogen may be used. On the liquid side, water, oil, or liquid macromolecules may be utilized. However, the selection of gas and liquid is not restricted. The fluid is retained sealingly inside the receiving space 111 as a buffer to distribute the depressing force from the user. Thus, when an external force is applied to the pressing face 112, the external force is acted on fluid inside the receiving space 111. The internal fluid transfers the force outwardly and downwardly inside the receiving space 111. As previously mentioned, the side faces 113 are less resilient relative to the insulating layer 20 and the first conducting layer 30. Thus, the internal fluid is restricted from expanding sideways. Instead, the fluid is forced to displace downward while transferring the depressing force to the insulating layer 20. Thus, the insulating layer 20 and the first conducting layer 30 are forced to deform.

As shown in FIG. 3, the pressing unit 10 may first be disposed on the insulating layer 20. The insulating layer 20 can be constructed of Mylar, polyethylene (PE) membrane, polypropylene (PP) membrane, polyvinyl chloride (PVC) membrane, polystyrene (PS) membrane, or other macromolecule membranes. The insulating layer 20 is then partially combined with the signal unit. The signal unit includes the first conducting layer 30, the spacer 40, and the second conducting layer 50. Because the pressing unit 10 is not in direct contact with the first conducting layer 30, when any of the pressing members 11 of the pressing unit 10 shows abnormality, only the pressing unit 10 needs to be replaced. For conventional key structures, the keys are formed directly on the membrane circuit board. When a defect key is found, the entire key assembly has to be replaced. Thus, the key structure 1 of the present invention is more cost-effective comparing to conventional key structures.

The first conducting layer 30 may be a circuit board membrane, a flexible circuit board, a printed circuit board, or any other device capable of transmitting electronic signals. The type of the first conducting layer 30 is not restricted. For the instant embodiment, the first conducting layer 30 is a membrane-structured membrane circuit board. The underside of the first conducting layer 30 is formed with a plurality of protruding first conducting portions 31. Each first conducting portion 31 is disposed under respective pressing member 11. The first conducting portions 31 can be made of electrically conductive materials such as conductive metals, graphite, or conductive polymers, but are not restricted thereto.

The second conducting layer 50 is arranged vertically below the first conducting layer 30. Likewise, the second conducting layer 50 may be a circuit board membrane, a flexible circuit board, a printed circuit board, or any other device capable of transmitting electronic signals. The type of the second conducting layer 50 is not restricted. For the instant embodiment, the second conducting layer 50 is a membrane-structured membrane circuit board. One side (i.e., the upper surface) of the second conducting layer 50 is formed with a plurality of second conducting portions 51 protrudingly. The second conducting portions 51 are arranged vertically below respective first conducting portions 31. Likewise, the second conducting portions 51 can be made of electrically conductive materials such as conductive metals, graphite, or conductive polymers, but are not restricted thereto.

The spacer 40 is disposed between the first conducting layers 30 and second conducting layers 50. The spacer 40 can be made of plastic, silica gel, resin, or other macromolecules. However, the material of the spacer 40 is not restricted. The spacer 40 is formed with a plurality of through holes 41. The through holes 41 allow the first conducting portions 31 to face directly toward the second conducting portions 51. In other words, the first conducting portions 31 and the second conducting portions 51 are arranged above and below the through holes 41, respectively. The first conducting portions 31 can selectively penetrate the through holes 41 and abut the second conducting portions 51.

As shown in FIG. 4, the key structure 1 can include the upper cover 60. The upper cover 60 is arranged on the pressing unit 10, and the upper cover 60 is formed with a plurality of openings 61. The pressing members 11 are exposed to the user by penetrating the openings 61. Thus, the openings 61 function to restrict lateral flexion of the pressing members 11. More specifically, when the pressing member 11 is depressed, the pressing member 11 will deform downwardly and laterally. However, the openings 61 restrict any significant deformation by the side faces 113 of the depressed pressing member 11. Thus, the pressing members 11 are prevented from bulging laterally. The restriction forces the depressed pressing member 11 to deform downwardly to press against the insulating layer 20. The lower cover 70 may be mounted to the underside of the second conducting layer 50 as a support means. The upper and lower covers 60 and 70 cooperate to protect the internal components of the key structure 1.

Please refer to FIG. 5, which is a cross-sectional view showing the key structure 1 at depressed state. The depressed pressing member 11 forces the first conducting layer 31 to abut against the second conducting layer 51. Therefore, electrical connection is established between. More specifically, when external force is exerted on the pressing face 112 of the pressing member 11, the applied force is transmitted vertically downward to the insulating layer 20. The insulating layer 20 is thus forced to push downward. The reason is as follows: the receiving space 111 of the pressing member 11 is a sealed space filled with fluid, the side faces 113 of the pressing member 11 are more rigid relative to the insulating layer 20 and the first conducting layer 30, and the opening 61 of the upper cover 60 restricts lateral deformation of the corresponding pressing member 11. Therefore, the internal fluid inside the receiving space 111 can only transfer the applied force downward to the insulating layer 20. The insulating layer 20 then squeezes the first conducting layer 30 in forcing the corresponding first conducting portion 31 downward. Since the first conducting portion 31 is held facing toward the second conducting portion 51, the first conducting portion 31 is forced into abutment with the second conducting portion 51 by penetrating the through hole 41 of the spacer 40. Thus, electrical communication is established between the first conducting portions 31 and second conducting portions 51, and signal transfer can be achieved.

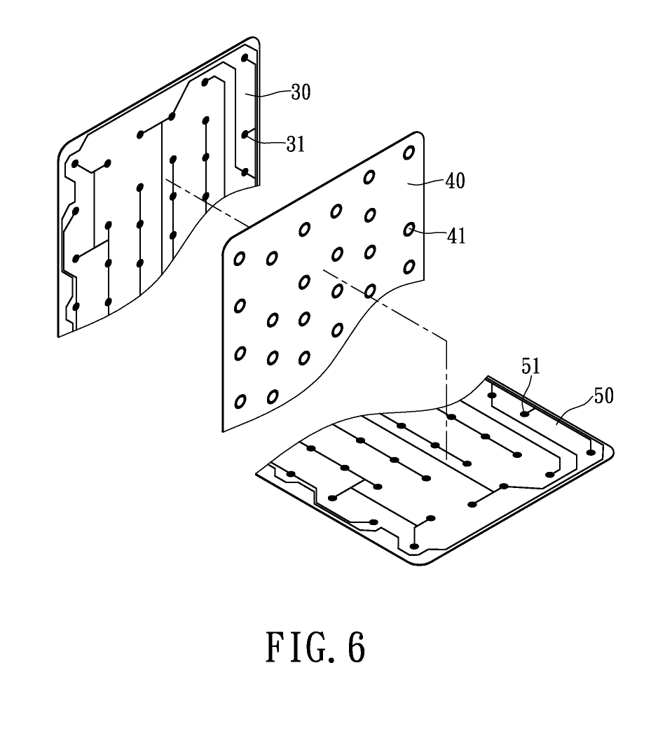

Please refer to FIG. 6, which shows the circuit layouts for the conducting layers of the key structure 1. The first conducting layers 30 and second conducting layers 50 have an electrical circuit to implement signal transmission and electrical communication. Electrical communication between the first conducting portions 31 and second conducting portions 51 is achieved through the electrical circuits of the first conducting layers 30 and second conducting layers 50 respectively. When the user intends to input a signal, the user can depress the pressing face 112 of the target pressing member 11. The fluid inside the receiving space 111 is pushed against the insulating layer 20. The insulating layer 20 squeezes the first conducting layer 30 into deformation. Thus, the first conducting portion 31 abuts the second conducting portion 51 to establish signal communication between. The aforementioned electrical circuits then transfer the user signal to the target destination.

The key structure 1 may be used for different types of keyboards or keypads. The applications include desktop computers, laptop computers, electronic dictionaries, e-book readers, land phones, mobile phones, mobile radios, remote controls, etc. The key structure 1 includes at least one pressing member 11. The shape of the key structure 1 may be square, rectangular, diamond-like, polygonal, circular, etc. The exact shape of the key structure 1 is determined by the intended application. In general, the key structure 1 may be used for keyboards or as user input interface for electrical or digital devices.

For advantages, the key structure of the present invention is stress-relieving and cost-effective. The utilization of internal fluid acts as a buffer that absorbs the applied force. When the user is stroking the keys repetitively for extended periods of time, the undesired physical stress and be greatly reduced, while operating the keys in a more comfortable manner. The improved key structure also generates substantially less noise, if not completely eliminated.

Furthermore, the key structure of the present invention is relatively thinner. The reduced thickness implies less weight, less material use, more environmentally friendly, and greater portability. Also, during the manufacturing process, the pressing unit is first combined with the insulating layer. The insulating layer is then combined with the first conducting layer. Thus, if any pressing member shows a sign of abnormality, the pressing unit can be conveniently replaced to increase the yield rate. The signal unit can be saved without replacing it. Thus, cost-effectiveness can be achieved.

The descriptions illustrated supra set forth simply the preferred embodiment of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A resilient key structure, comprising:
an insulating layer;
a pressing unit disposed on the insulating layer, the pressing unit having a plurality of pressing members, each pressing member having a pressing face subjectable to an external force and a plurality of side faces extending downward from the pressing face, the pressing face and the plurality of side faces of each pressing member and the insulating layer cooperate to define a fluid-filled receiving space for enclosing a fluid;
an upper cover disposed on the pressing unit and defining a plurality of openings penetrated by the plurality of pressing members while retaining the plurality of side faces of the plurality of pressing members;
a first conducting layer disposed underneath the insulating layer, the first conducting layer having a plurality of first conducting portions formed on an underside thereof, wherein the plurality of the first conducting portions respectively align to the plurality of the pressing members;
a second conducting layer arranged under the first conducting layer, the second conducting layer having a plurality of second conducting portions formed on an upper surface thereof, wherein the plurality of the second conducting portions respectively align to the plurality of the first conducting portions; and
a spacer disposed between the first conducting layer and the second conducting layer, the spacer defining a plurality of through holes that allows the plurality of first conducting portions to abut selectively with the plurality of second conducting portions;
wherein the plurality of side faces are more rigid than the insulating layer and the first conducting layer.

2. The resilient key structure of claim 1, wherein from the top toward the bottom, the upper cover, the pressing unit, the insulating layer, the first conducting layer, the spacer, and the second conducting layer are arranged sequentially.

3. The resilient key structure of claim 1, wherein the insulating layer is made of Mylar.

4. The resilient key structure of claim 1, wherein the plurality of pressing members are formed integrally on the pressing unit.

5. The resilient key structure of claim 1, wherein the first conducting layer and the second conducting layer are membrane-structure with electrical circuit.

6. The resilient key structure of claim 1, wherein the plurality of first conducting portions are formed protrudingly on the first conducting layer.

7. The resilient key structure of claim 1, wherein the plurality of first conducting portions utilize the electrical circuit of the first conducting layer to achieve electrical communication.

8. The resilient key structure of claim 1, wherein the plurality of second conducting portions are formed protrudingly on the second conducting layer.

9. The resilient key structure of claim 1, wherein the plurality of second conducting portions utilize the electrical circuit of the second conducting layer to achieve electrical communication.

10. The resilient key structure of claim 1, wherein each pressing member is capable of urging corresponding first conducting portion to abut with the corresponding second conducting portion, for establishing electrical connection between the first conducting portion and the second conducting portion.

11. The resilient key structure of claim 1, further comprising a lower cover mounted to the underside of the second conducting layer.

12. The resilient key structure of claim 11, wherein the upper cover assembles to the lower cover for protection.
